(19) United States
(12) Patent Application Publication
(10) Pub. No.: US 2006/0062400 A1
(43) Pub. Date: Mar. 23, 2006

(54) Bluetooth headset device capable of processing both audio and digital data signals

(75) Inventor: Tung Chia-Chun, Taipei City (TW)

Correspondence Address: TROXELL LAW OFFICE PLLC;SUITE 1404, 5205 LEESBURG PIKE, FALLS CHURCH, VA, 22041, US

(73) Assignee: BlueExpert Technology Corp.

(21) Appl. No.: 11/011,150

(22) Filed: Dec. 15, 2004

(30) Foreign Application Priority Data
Sep. 23, 2004 (TW) 93215171

(51) Int. Cl. H04R 1/10; H04R 25/00

(52) U.S. Cl. 381/74; 381/384

(57) ABSTRACT

A bluetooth headset for transmitting and receiving digital data and analog audio signal is disclosed. The bluetooth headset comprises: a bluetooth module for transmitting and receiving a wireless signal comprising a control signal, the format of the wireless signal being compliant with a bluetooth specification; an audio encoder/decoder for encoding an analog audio input signal to generate digital data, and decoding the digital data to generate an analog audio output signal; a memory unit for storing the digital data; and a control unit which is coupled to the bluetooth module for converting the wireless signal from received by the bluetooth module into the digital data, and transferring the digital data to one of the memory unit or the encoder/decoder.

### BACKGROUND OF INVENTION

1. Field of the Invention

This invention relates to a bluetooth headset device capable of processing both audio and digital data signals. More particularly, the invention relates to a bluetooth headset comprising a Bluetooth module, an audio encoder/decoder, a memory unit, a USB interface, and a data switch module.

2. Description of the Prior Art

Nowadays, a variety of portable electronic devices and peripherals are developed and widely used, such as Cellular Phones, Personal Digital Assistants (PDA), Flash Disks, Digital Cameras, MP3 Players, Mouses, Keyboards, IT Household Appliances, etc.

Conventionally, these devices cannot communicate to each other directly. If the direct communications are needed, theses devices have to be connected to a computer host through Universal Serial Bus (USB) interface. Recently, a wireless communication protocol called Bluetooth has been developed. Therefore, these different electronic devices, which have the Bluetooth module, can directly and wirelessly communicate to each other within a certain distance.

The conventional bluetooth headset can only transmit and receive the audio signals. The conventional bluetooth flash disks can only transmit and receive digital data. Up to days, there is no bluetooth headset can transmit and receive both the audio signals and digital data. This is possibly due to that the characteristic of the digital data and audio signals are different. When the bluetooth device receives a signal, it has to firstly determine whether the received signal is a digital data or an audio signal, and than process the received signal by an appropriate circuit. Therefore, the techniques would be more complicated than that of the conventional bluetooth device which can process only one type of the received signals. However, it would be inconvenient for the users if the bluetooth device can only process only one type of the received signals.

In the U.S. Pat. No. 6,725,302 and the U.S. Pat. No. 6,603,744 have disclosed some wireless USB hubs. Those techniques are different from the technical characteristics in the present invention.

### SUMMARY OF INVENTION

It is therefore one of the objectives of the claimed invention to provide a bluetooth headset for transmitting and receiving digital data and an analog audio signal. Thus, the technology of this invention can improve the convenience for users.

It is therefore one of objectives of the claimed invention to provide a bluetooth headset for transmitting and receiving digital data and an analog audio signal. The bluetooth headset can not only wirelessly transmit the audio signal to and from the bluetooth cellular phone such that the bluetooth headset of the invention is as a handsfree headset of the bluetooth cellular phone, but also can communicate with other bluetooth devices (for examples: PDAs, computers, MP3 players, digital cameras, and another bluetooth headset).

It is therefore one of the objectives of the claimed invention to provide a bluetooth headset for transmitting and receiving digital data and an analog audio signal. The bluetooth headset, which comprises a built-in MP3 controller, a memory component, and a USB interface, has the functions of a MP3 player, a flash disk, and a bluetooth headset.

It is therefore one of the objectives of the claimed invention to provide a bluetooth headset for transmitting and receiving digital data and an analog audio signal. The bluetooth headset can communicate with a computer with a built-in bluetooth module, whereas this computer is connected to the Internet and executes the Voice-Over-Internet Protocol (VoIP) software. Thus, the user can make Internet phone calls via the computer and the bluetooth headset of this invention.

According to the present invention, a bluetooth headset for transmitting and receiving digital data and analog audio signal is disclosed. The bluetooth headset comprises a bluetooth module for transmitting and receiving a wireless signal; an audio encoder/decoder for encoding an analog audio input signal to producing the digital data, and decoding the digital data to generate an analog audio output signal; a memory unit for storing digital data; a control unit which is coupled to the bluetooth module for converting the wireless signal from the bluetooth module into the digital data, and transferring the digital data to the audio encoder/decoder.

Preferably, the analog audio input signal received by the microphone is transferred to the memory unit or the bluetooth module according to the control signal.

Preferably, the digital data restored in the memory unit is controlled by the switch module to be transferred to the audio encode/decode or the bluetooth module is controlled by the switch.

Preferably, the wireless signal comprises a control signal, the control unit determines to convert the wireless signal received by the bluetooth module into the digital data or to transfer the wireless signal received by the bluetooth module into the audio encoder/decoder according to the control signal.

Preferably, the digital data received by the USB interface is transferred to the memory unit, or the bluetooth module, or the audio encoder/decoder; and wherein an audio input signal received by the microphone is processed by the control unit and is transferred to the external USB device through the USB interface.

These and other objectives of the claimed invention will no doubt become obvious to those of ordinary skill in the art after reading the following detailed description of the preferred embodiment that is illustrated in the various figures and drawings.

### BRIEF DESCRIPTION OF THE DRAWINGS

The details of the present invention will be more readily understood from a detailed description of the preferred embodiments taken in conjunction with the following figures.

FIG. 1 shows a functional block diagram of a first embodiment of the bluetooth headset according to the present invention;

FIG. 2 shows a functional diagram of a notebook that supports a bluetooth function and the bluetooth headset of the present invention;

FIG. 3 shows a functional diagram of a cell phone that supports a bluetooth function communicate with the bluetooth headset of the present invention;

FIG. 4 shows a functional diagram of a plurality of external bluetooth devices that support a bluetooth function communicate with the bluetooth headset of the present invention;

FIG. 5 shows a detailed circuit of the bluetooth module of the bluetooth headset according to the embodiment of the present invention;

FIG. 6 shows a detailed circuit of the switch module of the bluetooth headset according to the embodiment of the present invention;

FIG. 7 shows a detailed circuit of the headset of the bluetooth headset according to the embodiment of the present invention;

FIG. 8 shows a detailed circuit of the audio encoder/decoder of the bluetooth headset according to the embodiment of the present invention;

FIG. 9 shows a detailed circuit of the power module of the bluetooth headset according to the embodiment of the present invention;

FIG. 10 shows a detailed circuit of the USB interface of the bluetooth headset according to the embodiment of the present invention;

FIG. 11 shows a detailed circuit of the display module of the bluetooth headset according to the embodiment of the present invention;

FIG. 12 shows a detailed circuit of the memory unit of the bluetooth headset according to the embodiment of the present invention; and

FIG. 13 shows a detailed circuit of the control unit of the bluetooth headset according to the embodiment of the present invention.

### DETAILED DESCRIPTION

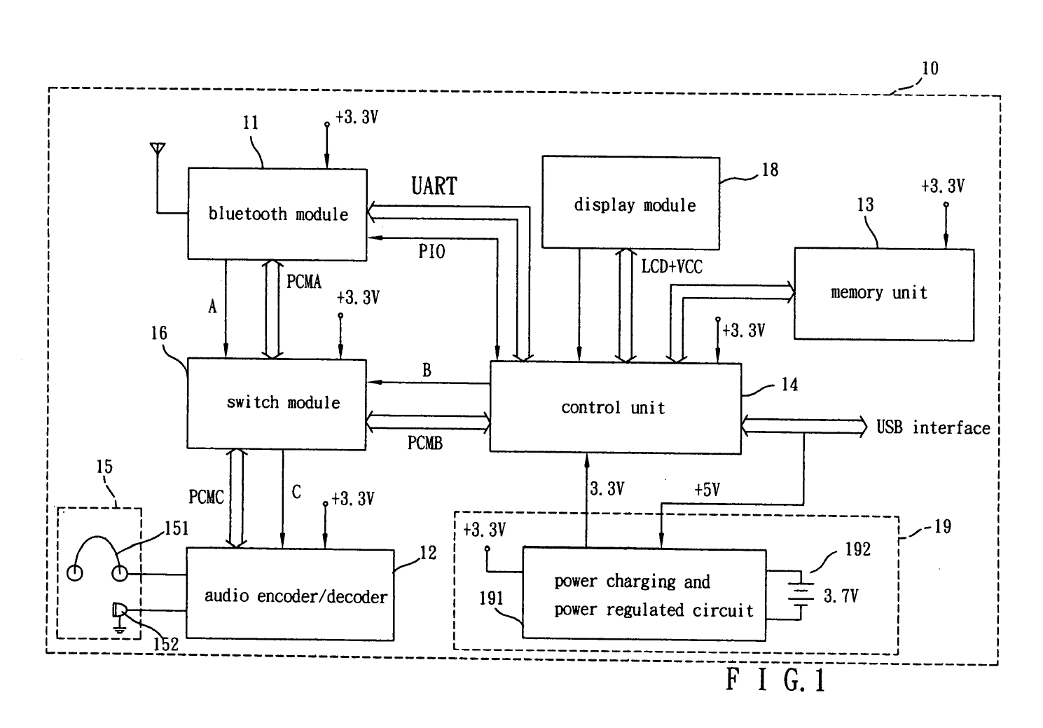

FIG. 1 shows a functional block diagram of the internal circuit of an embodiment of this invention. In this embodiment, a bluetooth headset 10 can wirelessly transmit a stereo audio signal and digital data. The bluetooth headset 10 comprises a bluetooth module 11, an audio encoder/decoder 12, a memory unit 13, a control unit 14, a headset 15, a switch module 16, a USB interface 17, a display module 18, and a power module 19.

The bluetooth module 11 receives and transmits a wireless signal utilizing the bluetooth protocol via an antenna 111. The wireless signal comprises at least a control signal and transmitted data. This control signal is used for determining whether the transmitted wireless signal is an audio signal or digital data. The bluetooth module 11 is a conventional device so that the detail illustration of this bluetooth module 11 is omitted.

The audio encoder/decoder 12 is used for processing a digital audio signal and an analog audio signal. The encoder/decoder 12 is also a conventional device so that the detail illustration of this device is beyond the scope of the description of this invention.

The memory unit 13 is used to store digital data. The memory unit 13 can be Flash Memory, Electric Programmable Read Only Memory (EPROM). The memory unit 13 also can be a Micro Hard Disk.

The control unit 14, which connected between the bluetooth module 11 and the memory unit 13, is used to receive the wireless signal from the bluetooth module 11. The control unit 14 converts the received wireless signal into digital data for storing in the memory unit 13 or transfers the wireless received signal to the stereo encoder/decoder 12 for transforming into an analogue signal according to the control signal of the received wireless signal.

The headset 15 is connected to the audio encoder/decoder 12 via a cable. The headset 15 comprises a stereo earphone 151 for playing the analog audio signal outputted from the audio encoder/decoder 12, and a microphone 152 for receiving a surroundings sound. The audio encoder/decoder 12 converts the analog received sound from the microphone 152 into the digital audio signal. Furthermore, the audio encoder/decoder 12 also converts a digital audio signal into the analog audio signal and outputs the analog audio signal to the stereo earphone 151.

The switch module 16 is connected to the audio encoder/decoder 12, the control unit 14, and the bluetooth module 11. Through control of this switch module 16, the audio encoder/decoder 12 can transfer data with either the bluetooth module 11 or the control unit 14. In this embodiment, the switch module 16 is a PCM data switch module 16. When the digital wireless signal received by the bluetooth module 11 is the digital data, the digital wireless signal is directly transferred to the control unit 14 via the UART port. When the control unit 14 determines that the digital wireless signal received by the bluetooth module 11 is an audio signal, this digital wireless signal, which is under the control of the switch module 16, is transferred to the audio encoder/decoder 12 via a path PCMC (FIG. 1), converted to an analog audio signal by the audio encoder/decoder 12, and transferred to the headset 15. Of course, the digital wireless signal, which is under the control of the switch module 16, can be transferred to the control unit 14 via a path PCM B, converted the digital wireless signal into the digital data. The digital data is stored into the memory unit 13 or is transferred to an external USB device via a USB interface 17. The external USB device can be a computer with a USB interface.

When the control unit 14 determines that the digital data stored in the memory unit 13 is the digital data signal, this digital data signal is transferred to the bluetooth module 11 via a UART port (FIG. 1). When the control unit 14 determines that the digital data stored in the memory unit 13 is the digital audio signal, this digital audio signal, which is under the control of the switch module 16, is transferred to the bluetooth module 11 via a path PCMA, or to the audio encoder/decoder 12 via the path PCMC, converted to an analog audio signal by the audio encoder/decoder 12, and transferred to the headset 15.

When the control unit 14 determines that the digital data from the USB interface 17 is the digital data signal, this digital data signal is transferred to the bluetooth module 11 via a UART port or to the memory unit 13. When the control unit 14 determines that the digital data from the USB interface 17 is the digital audio signal, the digital audio signal is transferred to the bluetooth module 11 via the PCMB and the PCMA or to the audio encoder/decoder 12 via the PCMB and the PCMC. The audio encoder/decoder 12 converts the digital audio signal into the analog audio signal and transfers the analog audio signal to the headset 15.

Furthermore, the microphone 152 of the headset 15 receives an analog audio signal and transfers the analog audio signal to the audio encoder/decoder 12. the audio encoder/decoder 12 converts the analog audio signal into the digital audio data and transfers the digital audio data to the memory unit 13 via the switch module 16, or to an external USB device via the switch module 16 and the USB interface 17, or to the another bluetooth device via the switch module 16 and the blurtooth transceiver 11.

A display module 18, which is connected to the control unit 14, is for displaying the state of the bluetooth headset 10 of the present invention. The display module 18 includes a touch panel for receiving a command of the user. The function of the bluetooth headset 10 is executed according to the command of the user. In a preferred embodiment, the display module 18 includes a LCD display module.

The power module 19 is for providing a power of the bluetooth headset of the present invention. In a preferred embodiment, the power module 19 includes a power charging and register circuit 191 and at least one rechargeable battery 192. The rechargeable battery 192 is for providing a 3.3 voltage to the blutooth headset 10 of the present invention via the power charging and register circuit 191. When the USB interface 17 is connected to an external USB device with a power source (i.e. computer), the power charging and register circuit 191 receives a 5.0 voltage from the USB interface 17, charges the rechargeable battery 192, and converts the 5.0 voltage into the 3.3 voltage to provide the bluetooth headset 10.

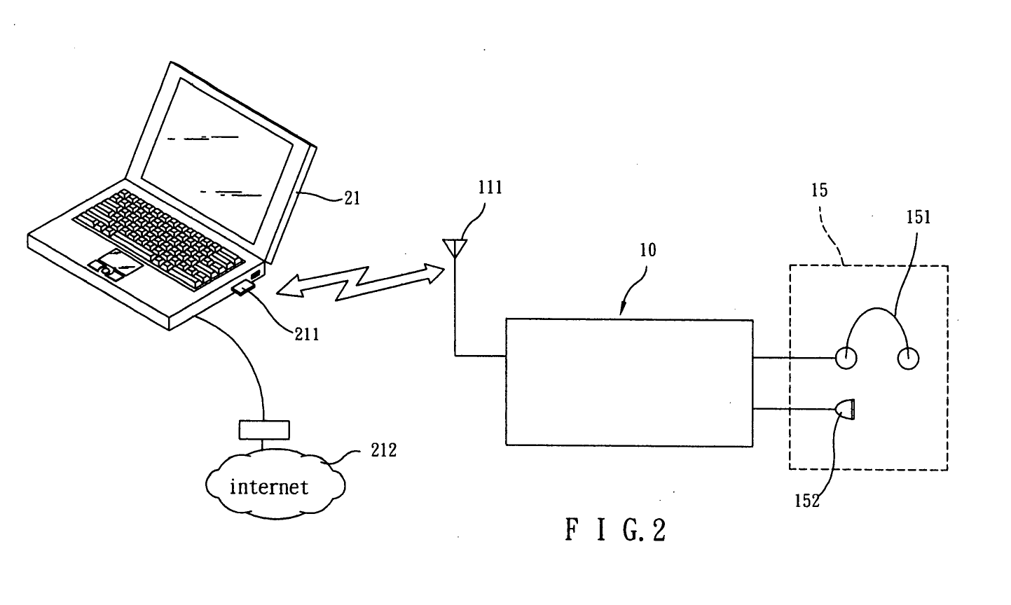

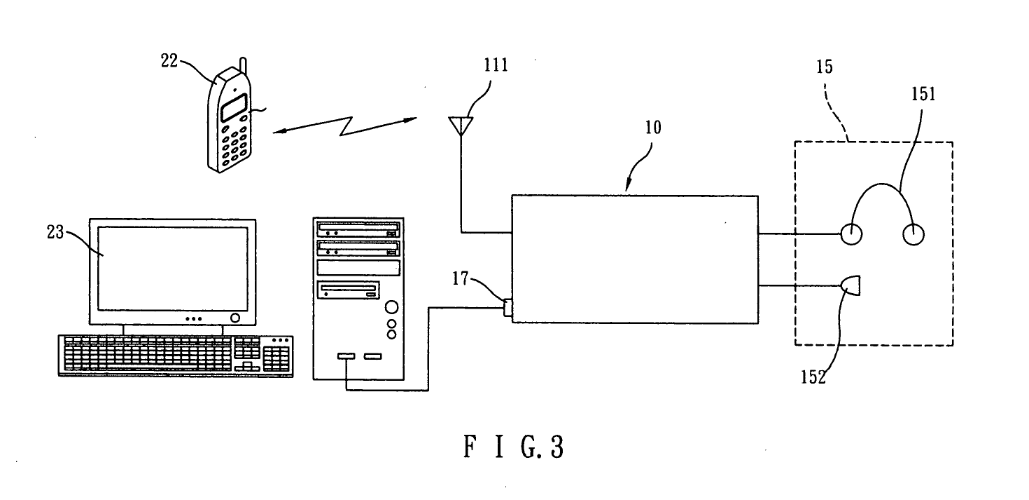

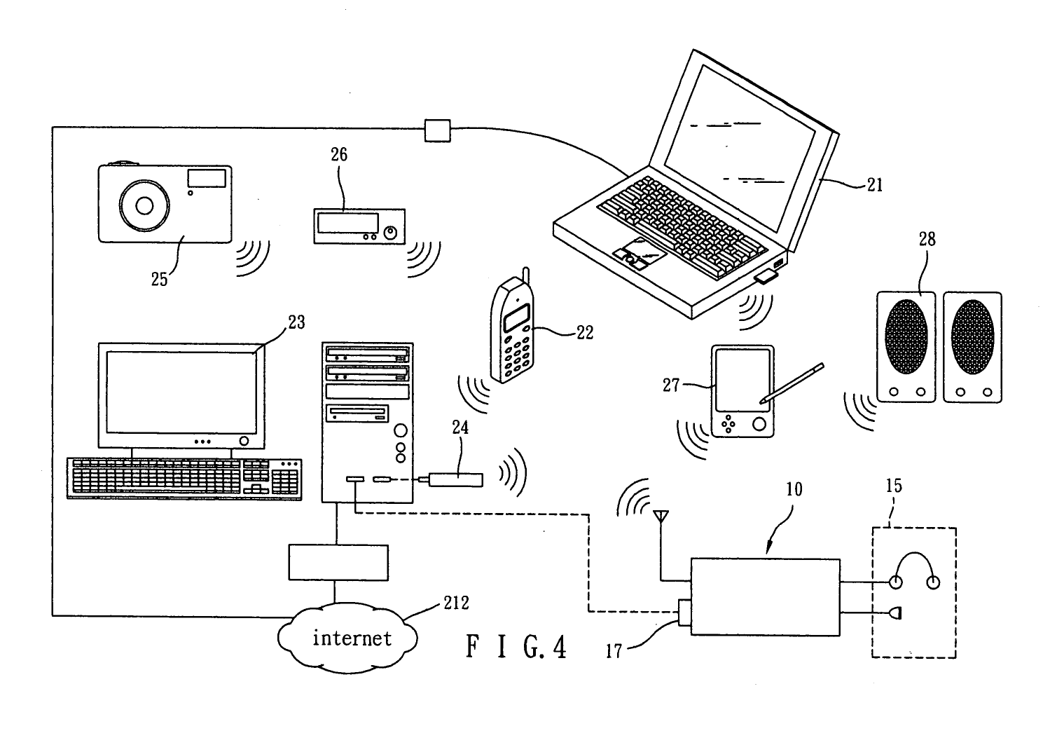

Please refer to FIG. 2, FIG. 3, and FIG. 4. FIG. 2˜4 show a block diagram of external devices connected to the bluetooth headset of the present invention.

FIG. 2 shows a block diagram of a computer, which includes the bluetooth module, connected to the bluetooth headset of the present invention. The bluetooth headset of the present invention can transfer the digital wireless signal to/from the external bluetooth device. When the external bluetooth device is a computer which includes a bluetooth module, the computer can transfer the digital wireless signal to the bluetooth headset 10 through the bluetooth module. If the digital wireless signal from the computer is not an audio signal, the digital wireless signal can be stored in the memory unit 13 so that the bluetooth headset 10 of the invention can act as the Flask Disk. If the digital wireless signal from the computer is an audio signal, the stereo earphone 151 of the bluetooth headset 10 can play the audio signal from the computer. The audio signal of the computer comes from MP3 file, wav file, CD, and DVD. When the computer link to the Internet and executes a Voice-Over-Internet Protocol (VoIP) software, the bluetooth headset 10 of this invention can act as a cordless telephone.

FIG. 3 shows a block diagram of a bluetooth cell phone connected to the bluetooth headset according to the present invention. The bluetooth headset 10 acts as a handsfree headset of the bluetooth cell phone. Because the volume of the memory unit of the bluetooth headset 10 of the invention is bigger than that of bluetooth cell phone, the digital data inside the Bluetooth cell phone 22, such as the calendar and the phone book, can be transmitted wirelessly through the Bluetooth module 11 to the Bluetooth headset 10 and be stored in the memory unit 13. The digital data in the Bluetooth headset 10 can also be transmitted back to the Bluetooth cell phone 22. As illustrated previously, the Bluetooth headset 10 can connect to a computer 23 through a USB interface 17. Thus, the Bluetooth cell phone 22 can communicate with the computer 23 through the bluetooh headset 10. Therefore, the Bluetooth headset 10 of the present invention can be applied widely and be convenient for users.

FIG. 4 shows a block diagram of the Bluetooth headset 10 and a plurality of the external Bluetooth devices. The Bluetooth headset 10 of this invention can wirelessly communicate with the computer 21 through the Bluetooth module 11 (FIG. 2). Through the computer 21, the Bluetooth headset 10 can connect to the Internet 212. The Bluetooth headset 10 also can wirelessly communicate to the Bluetooth cellular phone 22 (FIG. 3) or connect to an external USB device, such as the computer 23, through the USB interface 17. In additions, the Bluetooth headset 10 can wirelessly communicate with other Bluetooth devices, such as an external Bluetooth module 24 for computer, digital camera 25, MP3 player with a built-in Bluetooth module 26, PDA 27, Speaker 28, IT Household Appliance, and another Bluetooth headset. The Bluetooth headset 10 in this invention can is better than the conventional headset because it can process both audio signal and digital signal. Therefore, it can be applied widely and be convenient for users.

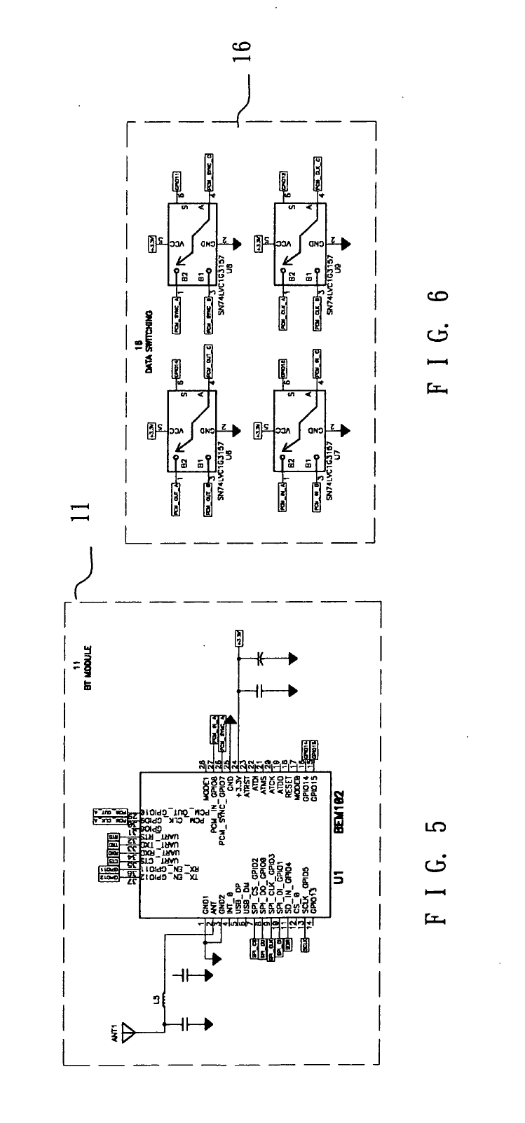

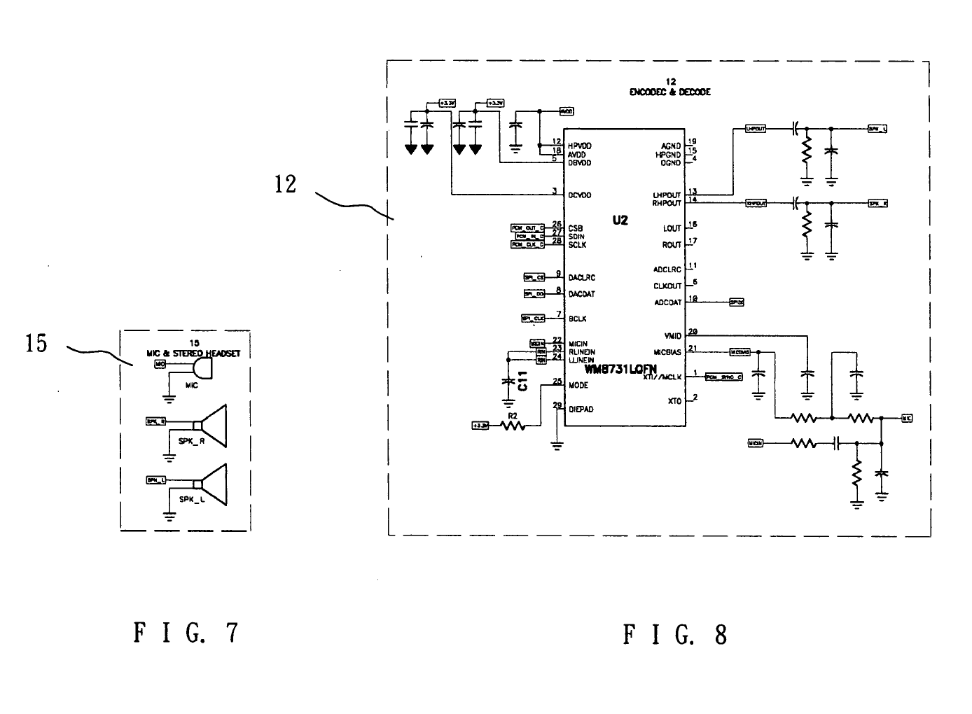

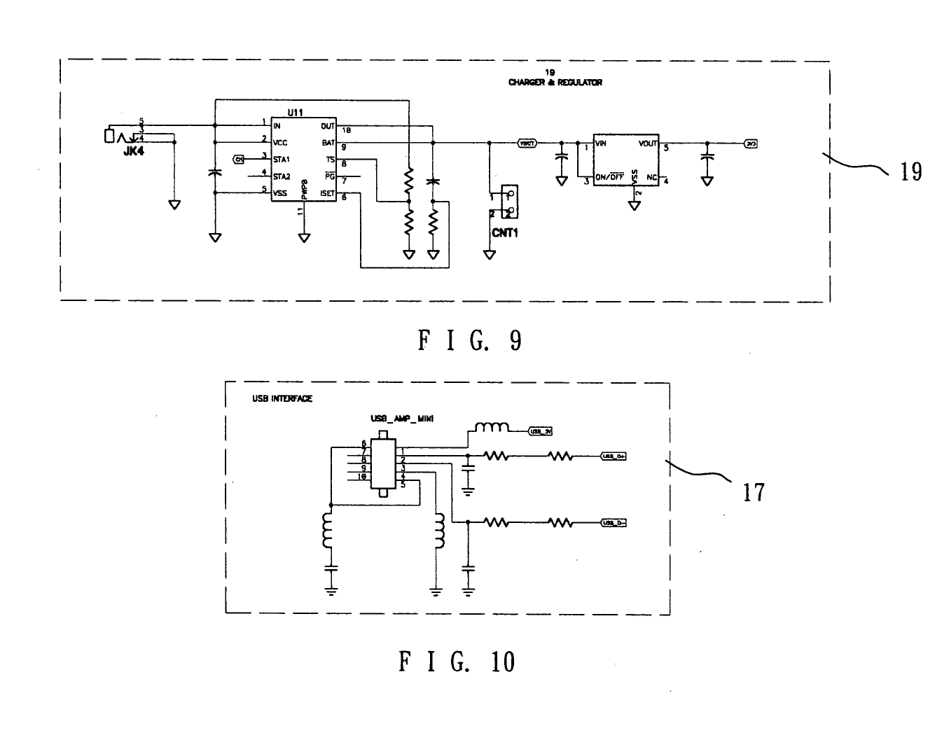

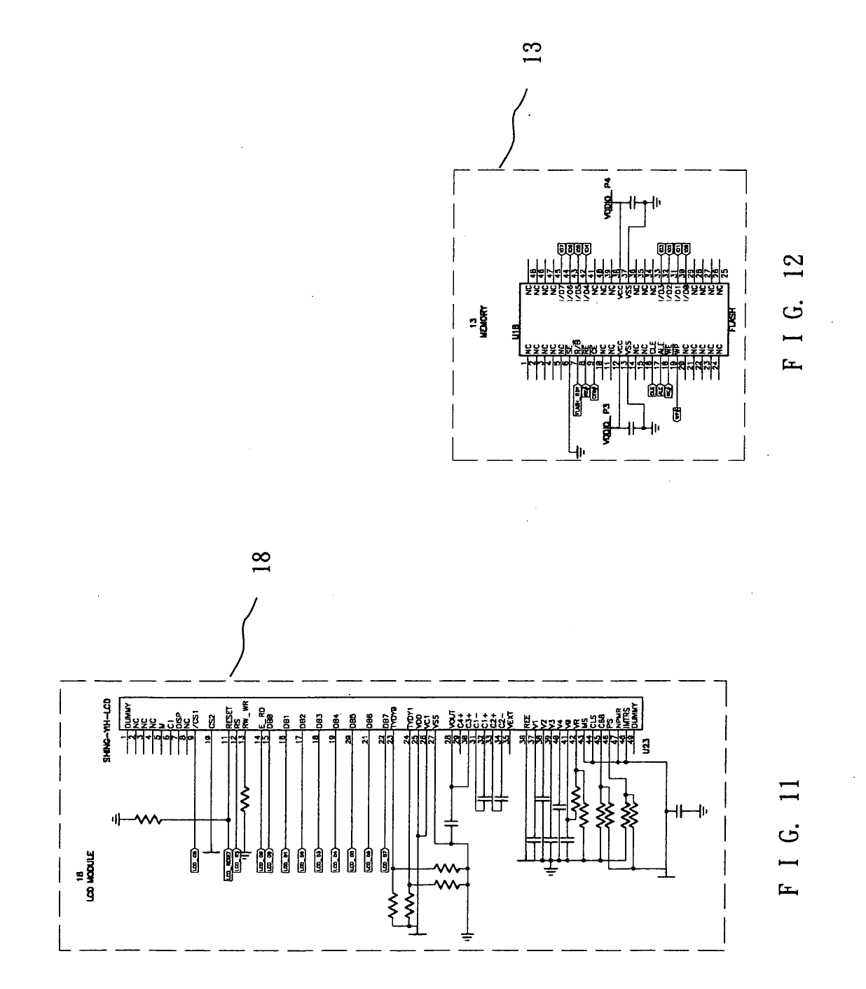

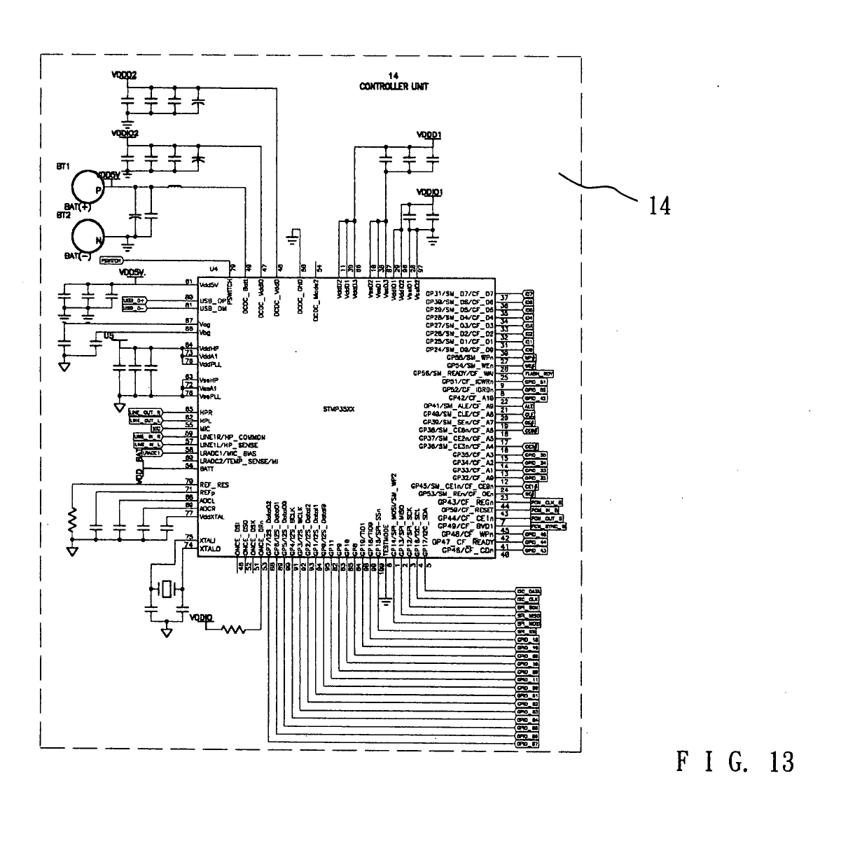

Please refer to FIG. 5˜FIG. 13. FIG. 5 shows a detailed circuit of the bluetooth module 11 of the bluetooth headset 10 according to the embodiment of the present invention. FIG. 6 shows a detailed circuit of the switch module 16 of the bluetooth headset 10 according to the embodiment of the present invention. FIG. 7 shows a detailed circuit of the headset 15 of the bluetooth headset 10 according to the embodiment of the present invention. FIG. 8 shows a detailed circuit of the audio encoder/decoder 12 of the bluetooth headset 10 according to the embodiment of the present invention. FIG. 9 shows a detailed circuit of the power module 19 of the bluetooth headset 10 according to the embodiment of the present invention. FIG. 10 shows a detailed circuit of the USB interface 17 of the bluetooth headset 10 according to the embodiment of the present invention. FIG. 11 shows a detailed circuit of the display module 18 of the bluetooth headset 10 according to the embodiment of the present invention. FIG. 12 shows a detailed circuit of the memory unit 13 of the bluetooth headset 10 according to the embodiment of the present invention. FIG. 13 shows a detailed circuit of the control unit 14 of the bluetooth headset 10 according to the embodiment of the present invention.

Those skilled in the art will readily observe that numerous modifications and alterations of the device may be made while retaining the teachings of the invention. Accordingly, that above disclosure should be construed as limited only by the metes and bounds of the appended claims.

What is claimed is:

1. A bluetooth headset device capable of processing both audio and digital data signals, comprising:
a bluetooth module for transmitting and receiving a wireless signal comprising a control signal, the format of the wireless signal being compliant with a bluetooth specification;
an audio encoder/decoder for encoding an analog audio input signal to generate digital data, and decoding the digital data to generate an analog audio output signal;
a memory unit for storing the digital data; and
a control unit which is coupled to the bluetooth module for converting the wireless signal received by the bluetooth module into the digital data, and transferring the digital data to one of the memory unit or the encoder/decoder.

2. The bluetooth headset device according to claim 1, further comprising:
a stereo headphone, connected to the audio encoder/decoder, for playing the analog audio output signal; and
a microphone, connected to the audio encoder/decoder, for receiving the analog audio input signal.

3. The bluetooth headset device according to claim 2, further comprising:
a switch module, connected to the bluetooth module, the control unit, and the audio encoder/decoder, for controlling the connection between and the audio encoder/decoder and one of the bluetooth module and the control unit;
wherein the switch module controls the analog audio input signal received by the microphone to be transferred to the bluetooth module or the memory unit; and
wherein the switch module controls the digital data stored in the memory unit to be transferred to the audio encoder/decoder or to the bluetooth module.

4. The bluetooth headset device according to claim 1, further comprising:
a USB interface, coupled to the control unit, for interfacing with an external USB device;
wherein the digital data received by the USB interface is processed by the control unit and, then, is transferred to the memory unit or the bluetooth module or the audio encoder/decoder; and
wherein the analog audio input signal received by the microphone is processed by the control unit and then the processed signal is transferred to the external USB device through the USB interface.

5. The bluetooth headset device according to claim 1, further comprising:
a digital display module coupled to the control unit; and
a power module for providing an electrical power of the bluetooth headset.

6. The bluetooth headset device according to claim 1, wherein the bluetooth module of the bluetooth headset communicates with other bluetooth module of an external bluetooth device, the external bluetooth device is one of a notebook with a bluetooth interface, a cell phone with a bluetooth interface, a computer with an external bluetooth interface, a digital still camera (DSC) having an internal bluetooth module, a PDA with a bluetooth interface, loud speaker with a bluetooth receiver, an information electrical device, and another bluetooth headset.

7. The bluetooth headset device according to claim 6, wherein the external bluetooth device is the computer with the bluetooth interface, and the bluetooth headset is as a Voice-Over-Internet Protocol (VoIP) when the computer is connected to an internet.

8. The bluetooth headset device according to claim 6, wherein the bluetooth headset is connected to the bluetooth cell phone, and the bluetooth headset acts as a handsfree headset of the bluetooth cell phone.

9. A bluetooth headset device for transmitting and receiving digital data and an analog audio signal, comprising:
a bluetooth module for transmitting and receiving a wireless signal, the format of the wireless signal being compliant with a bluetooth specification;
an audio encoder/decoder for encoding an analog audio input signal to generate digital data, and decoding the digital data to generate an analog audio output signal;
a microphone, connected to the audio encoder/decoder;
a stereo headphone connected to the audio encoder/decoder;
a memory unit for storing the digital data;
a control unit, coupled to the bluetooth module and the memory unit, for accessing the digital data stored in the memory unit, and processing the wireless signal received by the bluetooth module into the digital data, and writing the digital data into the memory unit; and
a switch module, connected to the bluetooth module, the control unit, and the audio encoder/decoder, for controlling the connection between the audio encoder/decoder and one of the control unit and the bluetooth module;
wherein an analog audio input signal received by the microphone is controlled by the switch module to be transferred to the memory unit or the bluetooth module; and
wherein the digital data restored in the memory unit is controlled by the switch module to be transferred to the audio encode/ decode or the bluetooth module is controlled by the switch.

10. The bluetooth headset device according to claim 9, wherein the wireless signal comprises a control signal, the control unit determines to convert the wireless signal received by the bluetooth module into the digital data or to transfer the wireless signal received by the bluetooth module into the audio encoder/decoder according to the control signal.

11. The bluetooth headset device according to claim 9, further comprising:
a USB interface, coupled to the control unit, for connecting to an external USB device,
wherein the digital data received by the USB interface is transferred to the memory unit, or the bluetooth module, or the audio encoder/decoder,
wherein an audio input signal received by the microphone is processed by the control unit and is transferred to the external USB device through the USB interface.

12. The bluetooth headset device according to claim 9, further comprising:
a digital display module, coupled to the control unit; and
a power module for providing an electrical power of the bluetooth headset.

13. The bluetooth headset device according to claim 9, wherein the bluetooth module of the bluetooth headset communicates with an external bluetooth device having other bluetooth module, the external bluetooth device is one of a notebook with a bluetooth interface, a cell phone with a bluetooth interface, a computer with an external bluetooth interface, a digital still camera (DSC) having an internal bluetooth module, a PDA with a bluetooth interface, loud speaker with a bluetooth receiver, an information electrical device, and another bluetooth headset.

14. The bluetooth headset device according to claim 13, wherein the external bluetooth device is the computer with the bluetooth interface, and the bluetooth headset is as a Voice-Over-Internet Protocol (VoIP) when the computer is connected to an internet.

15. The bluetooth headset device according to claim 13, wherein the bluetooth headset is connected to the bluetooth cell phone and the bluetooth headset acts as a handsfree headset of the bluetooth cell phone.

16. A bluetooth headset device for transmitting and receiving digital data and an analog audio signal, comprising:
a bluetooth module for transmitting and receiving a wireless signal the format of the wireless signal being compliant with a bluetooth specification;
a headphone;
a audio encoder/decoder, coupled to the headphone, for encoding an analog audio input signal to producing digital data, and decoding the digital data to generate an analog audio output signal;
a memory unit for storing the digital data;
a USB interface for connecting to an external USB device;
a control unit, coupled to the Bluetooth module, the USB interface, and the memory unit, having a MP3 module; and
a switch, connected to the bluetooth module, the control unit, and the audio encoder/decoder, for controlling the connection between the audio encoder/decoder and one of the control unit and the bluetooth module.

17. The bluetooth headset device according to claim 17, wherein
the analog audio input signal received by the microphone is controlled by the switch module to be transferred to the memory unit or the bluetooth module;
the digital data restored in the memory unit is controlled by the switch module to be transferred to the audio encode/decode or the bluetooth module is controlled by the switch;
the wireless signal comprises a control signal, the control unit determines to convert the wireless signal received by the bluetooth module into the digital data or to transfer the wireless signal received by the bluetooth module into the audio encoder/decoder according to the control signal;
the digital data received by the USB interface is transferred to the memory unit, or the bluetooth module, or the audio encoder/decoder; and
the audio input signal received by the microphone is processed by the control unit and is transferred to the external USB device through the USB interface.

18. The bluetooth headset device according to claim 16, further comprising:
a digital display module, coupled to the control unit; and
a power module for providing an electrical power of the Bluetooth headset.

19. The bluetooth headset device according to claim 16, wherein the bluetooth module of the bluetooth headset communicates with other bluetooth module of an external bluetooth device, the external bluetooth device is one of a notebook with a bluetooth interface, a cell phone with a bluetooth interface, a computer with an external bluetooth interface, a digital still camera (DSC) having an internal bluetooth module, a PDA with a bluetooth interface, loud speaker with a bluetooth receiver, an information electrical device, and another bluetooth headset.

20. The bluetooth headset device according to claim 19, wherein the external bluetooth device is the computer with the bluetooth module, and the bluetooth headset is as a Voice-Over-Internet Protocol (VoIP) when the computer is connected to an internet.
